(19) United States
(12) Patent Application Publication
(10) Pub. No.: US 2026/0169330 A1
(43) Pub. Date: Jun. 18, 2026

(54) DISPLAY DEVICE

(71) Applicants: CHENGDU BOE DISPLAY SCI-TECH CO., LTD., Chengdu (CN); BOE TECHNOLOGY GROUP CO., LTD., Beijing (CN)

(72) Inventors: Yanmei LUO, Beijing (CN); Lei LIU, Beijing (CN); Fan LI, Beijing (CN); Botao SUN, Beijing (CN); Wu WANG, Beijing (CN)

(21) Appl. No.: 18/728,175

(22) PCT Filed: Apr. 28, 2023
(86) PCT No.: PCT/CN2023/091543

§ 371 Date: Jul. 11, 2024

(51) Int. Cl. G02F 1/1343; G02F 1/1362

(52) U.S. Cl. CPC G02F 1/134345; G02F 1/13439; G02F 1/136286

(57) ABSTRACT

A display device includes a first display substrate, a second display substrate, and a liquid crystal layer located there between. The first display substrate includes first electrodes, first signal lines, and second signal lines; the second display substrate includes a second electrode. The first signal lines intersect with the second signal lines to define pixel regions, the first electrode within a same pixel region includes sub-electrodes electrically connected with each other; each sub-electrode includes strip electrodes and an electrode connection portion connected with the strip electrodes; a first gap is provided between adjacent strip electrodes; extension directions of strip electrodes in adjacent sub-electrodes intersect with each other; a second gap is provided between two adjacent sub-electrodes in each pixel region; the electrode connection portion is provided between the second gap and the first gap; and at least a portion of the second gap is surrounded by the first electrode.

### TECHNICAL FIELD

Embodiments of the present disclosure relate to a display device.

### BACKGROUND

With the development of liquid crystal display technology, a display device having a large size and high brightness is increasingly favored by people. Liquid crystal display devices include a twisted alignment display mode, a planar conversion display mode, and a vertical alignment display mode. The vertical alignment display mode, combined with advantages such as wide field of view and high contrast, may be widely used in large-sized display devices.

### SUMMARY

An embodiment of the present disclosure provides a display device, which includes a first display substrate, a second display substrate, and a liquid crystal layer located between the first display substrate and the second display substrate. The first display substrate includes a first base substrate as well as a plurality of first electrodes, a plurality of first signal lines, and a plurality of second signal lines located on the first base substrate; an arrangement direction of the plurality of first signal lines intersects with an arrangement direction of the plurality of second signal lines; the second display substrate is located on a side of the plurality of first electrodes that is away from the first base substrate; the second display substrate includes a second base substrate and a second electrode located on a side of the second base substrate that faces the first display substrate. The plurality of first signal lines intersects with the plurality of second signal lines to define a plurality of pixel regions, and first electrodes in different pixel regions are insulated from each other; in at least some pixel regions, the first electrode within a same pixel region includes a plurality of sub-electrodes electrically connected with each other; each sub-electrode includes a plurality of strip electrodes and an electrode connection portion connected with the plurality of strip electrodes; a first gap is provided between adjacent strip electrodes in each sub-electrode; extension directions of strip electrodes in adjacent sub-electrodes intersect with each other; a second gap is provided between at least two adjacent sub-electrodes in each pixel region; the electrode connection portion is provided between the second gap and the first gap; and at least a portion of the second gap is surrounded by the first electrode.

For example, according to an embodiment of the present disclosure, at least one sub-electrode includes the electrode connection portion with non-closed ring shape surrounding the plurality of strip electrodes, the electrode connection portion includes an opening, and the opening exposes one end of at least some strip electrodes.

For example, according to an embodiment of the present disclosure, the plurality of first signal lines is arranged along a first direction, and the plurality of second signal lines is arranged along a second direction; in a same pixel region, the plurality of sub-electrodes is arranged along one of the first direction and the second direction, and the opening only exposes one end of some strip electrodes.

For example, according to an embodiment of the present disclosure, a contour shape of the at least one sub-electrode includes a polygon, and the electrode connection portion surrounds at least two edges of the polygon.

For example, according to an embodiment of the present disclosure, two adjacent sub-electrodes within a same pixel region of at least one pixel region include electrode connection portions with non-closed ring shape surrounding the plurality of strip electrodes, the electrode connection portion includes an opening, and the opening expose one end of some strip electrodes; the same pixel region of the at least one pixel region includes a first sub-electrode and a second sub-electrode arranged adjacent to each other, the first sub-electrode is close to an edge of the same pixel region, and the second sub-electrode is close to a center of the same pixel region; an orientation of the opening of the electrode connection portion in the first sub-electrode is different from an orientation of the opening of the electrode connection portion in the second sub-electrode.

For example, according to an embodiment of the present disclosure, the plurality of first signal lines is arranged along a first direction, and the plurality of second signal lines is arranged along a second direction; the first sub-electrode and the second sub-electrode are arranged along the first direction, the opening of the electrode connection portion in the first sub-electrode faces the first signal line, and the opening of the electrode connection portion in the second sub-electrode faces the second signal line.

For example, according to an embodiment of the present disclosure, the orientation of the opening of the electrode connection portion in the first sub-electrode is opposite to the orientation of the opening of the electrode connection portion in the second sub-electrode.

For example, according to an embodiment of the present disclosure, the plurality of first signal lines is arranged along a first direction, the plurality of second signal lines is arranged along a second direction, and the first sub-electrode and the second sub-electrode are arranged along the first direction; the at least one pixel region includes two first sub-electrodes, openings of electrode connection portions in the two first sub-electrodes have a same orientation; or the opening of the electrode connection portion in one of the two first sub-electrodes faces the first signal line, and the opening of the electrode connection portion in the other of the two first sub-electrodes faces the second signal line.

For example, according to an embodiment of the present disclosure, the plurality of first signal lines is arranged along a first direction, and the plurality of second signal lines is arranged along a second direction; the first sub-electrode and the second sub-electrode are arranged along the first direction, the opening of the electrode connection portion in the first sub-electrode and the opening of the electrode connection portion in the second sub-electrode both face the second signal line, and a straight line extending along the first direction passes through an edge of the strip electrode in the first sub-electrode that is exposed by the opening and an edge of the electrode connection portion in the second sub-electrode.

For example, according to an embodiment of the present disclosure, the at least one pixel region includes four sub-electrodes arranged along one of the arrangement direction of the plurality of first signal lines and the arrangement direction of the plurality of second signal lines; among the four sub-electrodes, the second gap is provided between a 1-st sub-electrode and a 2-nd sub-electrode, and the second gap is provided between a 3-rd sub-electrode and a 4-th sub-electrode.

For example, according to an embodiment of the present disclosure, the plurality of first signal lines is arranged along a first direction, and the plurality of second signal lines is arranged along a second direction; in a same pixel region, the plurality of sub-electrodes is arranged in an array along the first direction and the second direction, the second gap is provided between adjacent sub-electrodes arranged along the first direction, and the second gap is provided between adjacent sub-electrodes arranged along the second direction.

For example, according to an embodiment of the present disclosure, at least one sub-electrode includes the electrode connection portion with a closed ring shape surrounding the plurality of strip electrodes.

For example, according to an embodiment of the present disclosure, more than 90% of the electrode connection portion is located between the plurality of strip electrodes of sub-electrodes arranged adjacent to each other in a same pixel region.

For example, according to an embodiment of the present disclosure, an included angle between the strip electrode and one of the arrangement direction of the plurality of first signal lines and the arrangement direction of the plurality of second signal lines is 30° to 80°.

For example, according to an embodiment of the present disclosure, a width of the strip electrode is 2 microns to 4 microns, and a width of the first gap is 2 microns to 4 microns.

For example, according to an embodiment of the present disclosure, a width of the second gap is 2 microns to 3.6 microns, and a ratio of the width of the second gap to a width of the strip electrode is 0.5 to 2.

For example, according to an embodiment of the present disclosure, one of the first display substrate and the second display substrate includes an alignment film having undergone alignment treatment, the alignment film is located between the liquid crystal layer and the second electrode; or, both the first display substrate and the second display substrate include alignment films having undergone alignment treatment.

For example, according to an embodiment of the present disclosure, the first display substrate further includes a plurality of conductive portions arranged in the same layer as, and insulated from, the plurality of first signal lines, at least some conductive portions include a first conductive portion extending along the arrangement direction of the plurality of first signal lines and a second conductive portion extending along the arrangement direction of the plurality of second signal lines, in a direction perpendicular to the first base substrate, the first conductive portion does not overlap with the second signal line, and both the first conductive portion and the second conductive portion overlap with the first electrode.

For example, according to an embodiment of the present disclosure, the first display substrate further includes a connection structure connecting conductive portions located on both sides of the first signal line, the connection structure is arranged in the same layer as, and insulated from, the first electrode; in the direction perpendicular to the first base substrate, the connection structure overlaps with the first signal line, and an overlapping portion of the connection structure and the first signal line includes a first recess.

For example, according to an embodiment of the present disclosure, a straight line extending along the second direction passes through the first electrode and the connection structure, the first electrode is provided with a second recess to avoid the connection structure, and the second recess is formed by the electrode connection portion being recessed towards one side of the strip electrode.

Another embodiment of the present disclosure provides a display device, which includes: a first display substrate, a second display substrate, and a liquid crystal layer located between the first display substrate and the second display substrate. The first display substrate includes a first base substrate, as well as a plurality of first electrodes, a plurality of first signal lines, and a plurality of second signal lines located on the first base substrate, the plurality of first signal lines is arranged along a first direction, the plurality of second signal lines is arranged along a second direction, and the first direction intersects with the second direction; the second display substrate is located on a side of the plurality of first electrodes that is away from the first base substrate, the second display substrate includes a second base substrate and a second electrode located on a side of the second base substrate that faces the first display substrate. The plurality of first signal lines intersects with the plurality of second signal lines to define a plurality of pixel regions, and first electrodes in different pixel regions are insulated from each other; in at least some pixel regions, the first electrode within a same pixel region includes a plurality of sub-electrodes electrically connected with each other, each sub-electrode includes a plurality of strip electrodes, a first gap is provided between adjacent strip electrodes in each sub-electrode; extension directions of strip electrodes located in adjacent sub-electrodes are respectively parallel to the first direction and the second direction, and each sub-electrode further includes a closed ring electrode connection portion surrounding the plurality of strip electrodes.

For example, according to an embodiment of the present disclosure, in at least one pixel region, a same pixel region includes four sub-electrodes arranged in an array along the first direction and the second direction.

### BRIEF DESCRIPTION OF DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1 is a schematic diagram of a partial planar structure of a display device.

FIG. 2 is a schematic diagram of one pixel region when the display device shown in FIG. 1 is displaying.

FIG. 3 is a schematic diagram of a partial cross-sectional structure of a display device provided by an embodiment of the present disclosure.

FIG. 4 is a schematic diagram of a partial planar structure of a first display substrate in the display device shown in FIG. 3.

FIG. 5 is a schematic diagram of one pixel region when the display device shown in FIG. 4 is displaying.

FIG. 6 to FIG. 10 are schematic diagrams of different film layers in the first display substrate shown in FIG. 5.

FIG. 11 is a schematic diagram of a partial planar structure of a first display substrate provided by another example according to the embodiment of the present disclosure.

FIG. 12A and FIG. 12B are schematic diagrams of an arrangement structure of a film layer where the first electrode is located shown in FIG. 11 in different examples.

FIG. 13 is a schematic diagram of a partial planar structure of a first display substrate provided by another example according to the embodiment of the present disclosure.

FIG. 14 is a schematic diagram of an arrangement structure of a film layer where the first electrode is located shown in FIG. 13.

FIG. 15 is a schematic diagram of a partial planar structure of a first display substrate provided by another example according to the embodiment of the present disclosure.

FIG. 16 is a schematic diagram of an arrangement structure of a film layer where the first electrode is located shown in FIG. 15.

FIG. 17 is a schematic diagram of a partial planar structure of a first display substrate provided by another example according to the embodiment of the present disclosure.

FIG. 18 is a schematic diagram of an arrangement structure of a film layer where the first electrode is located shown in FIG. 17.

FIG. 19 is a schematic diagram of a partial planar structure of a display device provided by another embodiment of the present disclosure.

FIG. 20 is a schematic diagram of an arrangement structure of a film layer where the first electrode is located shown in FIG. 19.

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present application for disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects.

Features such as “parallel”, “perpendicular” and “identical”, etc. used in the embodiments of the present disclosure all include strictly defined features such as “parallel”, “perpendicular” and “identical”, as well as cases where certain errors are included such as “substantially parallel”, “substantially perpendicular” and “substantially identical”, considering that errors related to measurement and measurement of a specific quantity (e.g., limitations of a measurement system) indicate that such features are within an acceptable deviation range for a specific value determined by those ordinarily skilled in the art. For example, the expression “substantially” may indicate that features are within one or more standard deviations, or within 10% or 5% of a value. When a quantity of a component is not specifically specified in the following text of the embodiments of the present disclosure, it means that the quantity of such component may be one or more, or may be understood as at least one. The expression “at least one” refers to one or more, and “more” refers to at least two.

The “integrated structure” in this disclosure refers to two (or more) structures which are formed by the same deposition process and patterned by the same patterning process, and their materials may be the same or different.

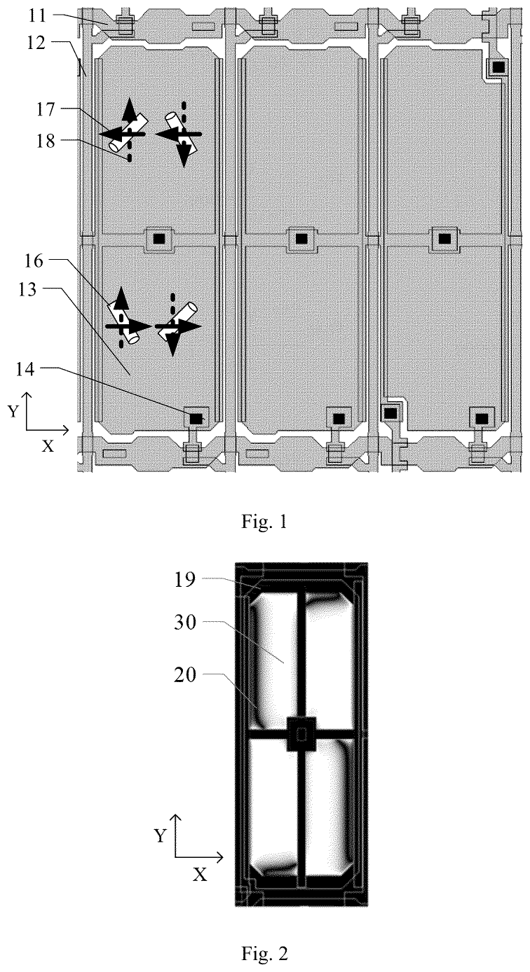

FIG. 1 is a schematic diagram of a partial planar structure of a display device; and FIG. 2 is a schematic diagram of one pixel region when the display device shown in FIG. 1 is displaying.

As shown in FIG. 1 and FIG. 2, the display device includes an array substrate; a display substrate includes a plurality of gate lines 11 and a plurality of data lines 12; the gate lines 11 extend along an X direction; the data lines 12 extend along a Y direction; and the plurality of gate lines 11 and the plurality of data lines 12 are insulated from and intersect with each other to define a plurality of pixel regions.

For example, as shown in FIG. 1 and FIG. 2, the pixel region is provided with a pixel electrode 13 and a thin film transistor 14; the gate line 11 is electrically connected with a gate electrode of the thin film transistor 14 to turn on or off the thin film transistor 14; the pixel electrode 13 is electrically connected with one of a source electrode and a drain electrode of the thin film transistor 14; the data line 12 is electrically connected with the other of the source electrode and the drain electrode of the thin film transistor 14; and the data line 11 inputs a voltage signal required for displaying a picture to the pixel electrode 13 through the thin film transistor 14 so that the display device displays.

The display device shown in FIG. 1 further includes an opposite substrate provided opposite to the array substrate, for example, a color filter substrate; and a liquid crystal layer 16 is provided between the array substrate and the color filter substrate. A solid line arrow shown in FIG. 1 represents an alignment direction 17 on an alignment film provided in the array substrate; for example, the alignment direction 17 includes two opposite directions parallel to the X direction; a dashed line arrow shown in FIG. 1 represents an alignment direction 18 on the alignment film provided in the color filter substrate, for example, the alignment direction 18 includes two opposite directions parallel to the Y direction. An initial alignment direction of a liquid crystal in the liquid crystal layer 16, for example, a pre-tilt angle, is determined jointly by the alignment film in the array substrate and the alignment film in the color filter substrate.

As shown in FIG. 1, the alignment film in the array substrate corresponds to two opposite alignment directions 17 arranged in the same pixel region position; and the alignment film in the color filter substrate corresponds to two opposite alignment directions 18 arranged in the same pixel region position; so the liquid crystal 16 within the same pixel region has four deflection directions under a joint action of the alignment films on two sides thereof, to form four domains. By setting a plurality of domains in one pixel region, diversity of liquid crystal rotation directions is increased to alleviate a color cast problem of the display device in a large viewing angle.

As shown in FIG. 2, the display device further includes a black matrix 19 for defining the pixel region 30. For example, the black matrix 19 may be located on the color filter substrate.

In the study, an inventor of the present application has found that in a display device adopting the vertical alignment display technology, liquid crystal molecules have inconsistent orientations at a boundary between domains with respect to multi-domain display, for example, the liquid crystal molecules have disordered orientations in an inter-domain boundary position where the liquid crystal molecules have opposite orientations, forming an inter-domain dark stripe 20 shown in FIG. 2, which reduces transmittance of the display device.

The present disclosure provides a display device, including: a first display substrate, a second display substrate, and a liquid crystal layer located between the first display substrate and the second display substrate. The first display substrate includes a first base substrate as well as a plurality of first electrodes, a plurality of first signal lines, and a plurality of second signal lines located on the first base substrate; an arrangement direction of the plurality of first signal lines intersects with an arrangement direction of the plurality of second signal lines; the second display substrate is located on a side of the plurality of first electrodes that is away from the first base substrate; the second display substrate includes a second base substrate and a second electrode located on a side of the second base substrate that faces the first display substrate. The plurality of first signal lines intersects with the plurality of second signal lines to define a plurality of pixel regions, and first electrodes in different pixel regions are insulated from each other; in at least some pixel regions, the first electrode within a same pixel region includes a plurality of sub-electrodes electrically connected with each other; each sub-electrode includes a plurality of strip electrodes and an electrode connection portion connected with the plurality of strip electrodes; a first gap is provided between adjacent strip electrodes in each sub-electrode; extension directions of strip electrodes in adjacent sub-electrodes intersect with each other; a second gap is provided between at least two adjacent sub-electrodes in each pixel region; the electrode connection portion is provided between the second gap and the first gap; and at least a portion of the second gap is surrounded by the first electrode. By providing the plurality of sub-electrodes in the same pixel region, each sub-electrode including the plurality of strip electrodes, and strip electrodes in different sub-electrodes having different extension directions, multi-domain display may be implemented in the same pixel region; moreover, by providing the second gap between two adjacent sub-electrodes, and providing the electrode connection portion between the second gap and the first gap, edges of strip electrodes in adjacent sub-electrodes that are close to each other applied with an electric field may be prevented from producing a significant impact on deflection of liquid crystal molecules in a boundary position of the two adjacent sub-electrodes, so as to alleviate deflection direction disorder of liquid crystal molecules between the two adjacent sub-electrodes, which is favorable for alleviating an inter-domain dark stripe to improve transmittance of the display device.

The present disclosure provides another display device, including: a first display substrate, a second display substrate, and a liquid crystal layer located between the first display substrate and the second display substrate. The first display substrate includes a first base substrate as well as a plurality of first electrodes, a plurality of first signal lines, and a plurality of second signal lines located on the first base substrate; the plurality of first signal lines is arranged along a first direction; the plurality of second signal lines is arranged along a second direction; the first direction intersects with the second direction; the second display substrate is located on a side of the plurality of first electrodes that is away from the first base substrate; the second display substrate includes a second base substrate and a second electrode located on a side of the second base substrate that faces the first display substrate. The plurality of first signal lines and the plurality of second signal lines intersect with each other to define a plurality of pixel regions; first electrodes in different pixel regions are insulated from each other; in at least some pixel regions, a first electrode within a same pixel region includes a plurality of sub-electrodes electrically connected with each other; each sub-electrode includes a plurality of strip electrodes; a first gap is provided between adjacent strip electrodes in each sub-electrode; extension directions of strip electrodes located in adjacent sub-electrodes are respectively parallel to the first direction and the second direction; and respective sub-electrodes further include a closed ring electrode connection portion surrounding the plurality of strip electrodes. By matching alignment directions of alignment films in respective display substrates with extension directions of strip electrodes in different sub-electrodes while providing the plurality of sub-electrodes including strip electrodes in the first electrode, and setting the electrode connection portion as a closed ring, it is favorable for alleviating the phenomenon of liquid crystal molecule deflection disorder at a boundary of adjacent sub-electrodes, thereby alleviating a dark stripe and improving transmittance of the display device.

The display device provided by the embodiment of the present disclosure will be described below in conjunction with the accompanying drawings.

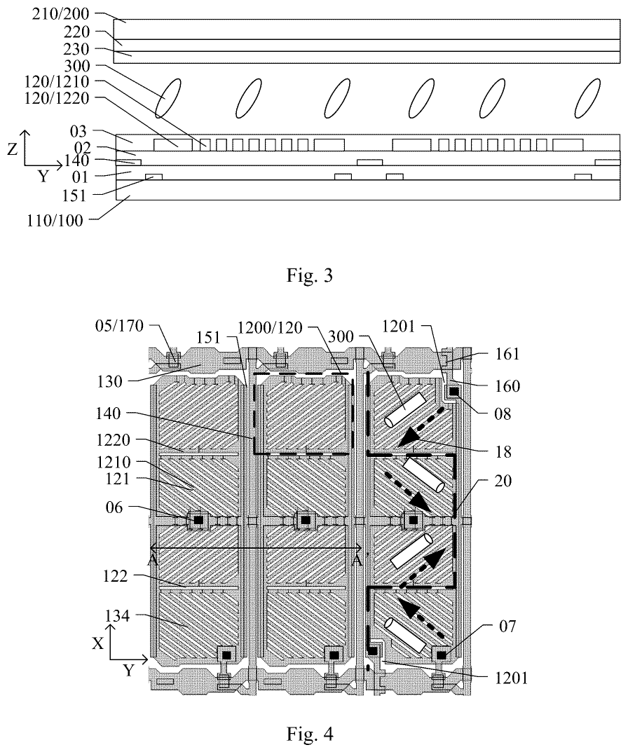

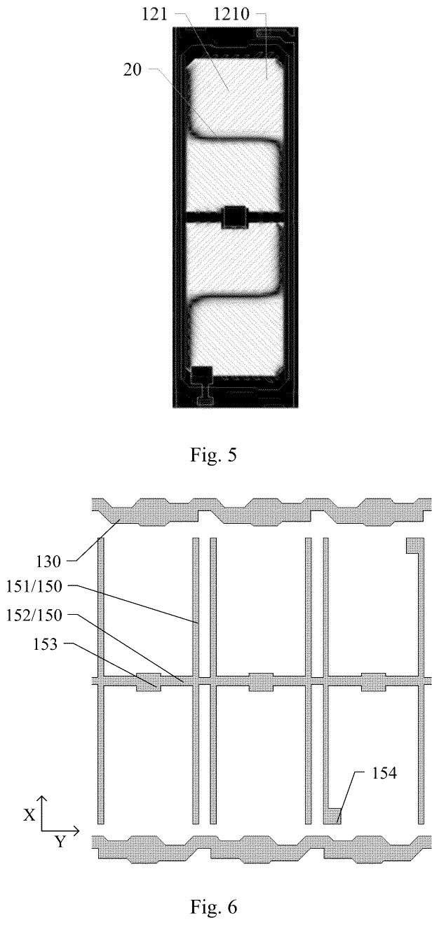

FIG. 3 is a schematic diagram of a partial cross-sectional structure of the display device provided by the embodiment of the present disclosure; and FIG. 4 is a schematic diagram of a partial planar structure of a first display substrate in the display device shown in FIG. 3. FIG. 5 is a schematic diagram of one pixel region when the display device shown in FIG. 4 is displaying. FIG. 6 to FIG. 10 are schematic diagrams of different film layers in the first display substrate shown in FIG. 5. FIG. 3 is a schematic diagram of a partial cross-sectional structure sectioned along an AA′ line shown in FIG. 4.

As shown in FIG. 3 and FIG. 4, the display device includes a first display substrate 100 and a second display substrate 200 arranged opposite to each other, as well as a liquid crystal layer 300 located between the first display substrate 100 and the second display substrate 200. The first display substrate 200 includes a first base substrate 110, as well as a plurality of first electrodes 120, a plurality of first signal lines 130, and a plurality of second signal lines 140 located on the first base substrate 110; and an arrangement direction of the plurality of first signal lines 130 intersects with an arrangement direction of the plurality of second signal lines 140.

In some examples, as shown in FIG. 4, the plurality of first signal lines 130 extend along a first direction; and the plurality of second signal lines 140 extend along a second direction. For example, FIG. 4 schematically shows that the first direction is an X direction and the second direction is a Y direction, but it is not limited thereto, and the first direction and the second direction may be interchanged. For example, the first direction intersects with the second direction. For example, an included angle between the first direction and the second direction may be 80 degrees to 100 degrees. For example, the first direction is perpendicular to the second direction.

For example, as shown in FIG. 4, one of the first signal line 130 and the second signal line 140 is configured to transmit a data signal, and the other is configured to transmit a gate signal. For example, the first signal line 130 may be a gate line for transmitting a gate signal, and the second signal line 140 may be a data line for transmitting a data signal, but it is not limited thereto, and the first signal line and the second signal line may be interchanged.

As shown in FIG. 4, the second display substrate 200 is located on a side of the plurality of first electrodes 120 that is away from the first base substrate 110; and the second display substrate 200 includes a second base substrate 210 and a second electrode 220 located on a side of the second base substrate 210 that faces the first display substrate 100.

For example, as shown in FIG. 4, the first electrode 120 may be the pixel electrode; and the second electrode 220 may be the common electrode. For example, the first electrode 120 and the second electrode 220 may be made of a transparent conductive material. For example, the material of the first electrode 120 may include indium tin oxide (ITO).

As shown in FIG. 3 and FIG. 4, the plurality of first signal lines 130 and the plurality of second signal lines 140 intersect with each other to define a plurality of pixel regions 134; and first electrodes 120 in different pixel regions 134 are insulated from each other.

For example, as shown in FIG. 4, each pixel region 134 is a region where one sub-pixel is located, and, for example, may also be referred to as a display region, for displaying light of one color. For example, a boundary of each pixel region 134 may be a boundary surrounded by four edges of the first signal line 130 and the second signal line 140 that are closest to the center of the pixel region 134. For example, a black matrix is provided between adjacent pixel regions 134. For example, the first signal line 130 or the second signal line 140 is provided between adjacent pixel regions 134. For example, the plurality of pixel regions 134 are arranged in an array along the first direction and the second direction. The above-described center of the pixel region refers to the geometric center of the pixel region, for example, the geometric center may overlap with a second conductive portion 152 (described later).

As shown in FIG. 3 and FIG. 4, in at least some pixel regions 134, the first electrode 120 within the same pixel region 134 includes a plurality of sub-electrodes 1200 electrically connected with each other; and each sub-electrode 1200 includes a plurality of strip electrodes 1210 and an electrode connection portion 1220 connected with the plurality of strip electrodes 1210.

For example, as shown in FIG. 3 and FIG. 4, first electrodes 120 included in respective pixel regions 134 each include a plurality of sub-electrodes 1200. For example, strip electrodes 1210 of each sub-electrodes 1200 are electrically connected with each other through the electrode connection portion 1220. For example, the strip electrode 1210 has at least one end connected with the electrode connection portion 1220.

For example, as shown in FIG. 3 and FIG. 4, the strip electrode 1210 and the electrode connection portion 1220 may be an integrated structure. For example, a plurality of sub-electrodes 1200 included in the same first electrode 120 may be an integrated structure, or may also be a structure arranged at intervals and electrically connected with each other through other conductive layers.

For example, as shown in FIG. 3 and FIG. 4, in the same pixel region 134, a region where each sub-electrode 1200 is located is one domain; different sub-electrodes 1200 are located in different domains; and the same pixel region 134 includes a plurality of domains. For example, the numbers of strip electrodes 1210 included in different sub-electrodes 1200 may be the same or different. For example, in at least one pixel region 134, the numbers of strip electrodes 1210 included in respective sub-electrodes 1200 are the same. For example, in at least one pixel region 134, the number of strip electrodes 1210 included in at least one sub-electrode 1200 is different from the number of strip electrodes 1210 included in other sub-electrodes 1200.

As shown in FIG. 3 and FIG. 4, in the same pixel region 134, a first gap 121 is provided between adjacent strip electrodes 1210 in each sub-electrode 1200; and extension directions of strip electrodes 1210 in adjacent sub-electrodes 1200 intersect with each other. For example, the plurality of strip electrodes 1210 in each sub-electrode 1200 are arranged in parallel; and in the same pixel region 134, an included angle between extension directions of strip electrodes 1210 in adjacent sub-electrodes 1200 is 20 degrees to 90 degrees, for example, 30 degrees to 85 degrees, for example, 40 degrees to 80 degrees, for example, 45 degrees to 60 degrees, etc.

For example, as shown in FIG. 4, the first gap 121 has a shape of strip. For example, respective positions of the first gap 121 have an equal width.

For example, as shown in FIG. 3 and FIG. 4, the width ratio of different strip electrodes 1210 in the same sub-electrode 1200 is 0.95 to 1.05, and the width ratio of strip electrodes 1210 in different sub-electrodes 1200 is 0.95 to 1.05; the width ratio of different first gaps 121 in the same sub-electrode 1200 is 0.95 to 1.05, and the width ratio of first gaps 121 in different sub-electrodes 1200 is 0.95 to 1.05.

For example, the widths of different strip electrodes 1210 in the same sub-electrode 1200 are equal, and the widths of strip electrodes 1210 in different sub-electrodes 1200 are equal; the widths of different first gaps 121 in the same sub-electrode 1200 are equal, and the widths of the first gaps 121 in different sub-electrodes 1200 are equal.

In some examples, as shown in FIG. 3 and FIG. 4, the width of the strip electrode 1210 is 2 microns to 4 microns, and the width of the first gap 121 is 2 microns to 4 microns. For example, the width of the strip electrode 1210 is 2.5 microns to 3.5 microns, for example, 2.8 microns to 3.2 microns, for example, 3 microns. For example, the width of the first gap 121 is 2.2 microns to 3 microns, for example, 2.4 microns to 2.8 microns, for example, 2.6 microns.

For example, the width of the strip electrode 1210 is greater than the width of the first gap 121, which is favorable for increasing electric field intensity. For example, the ratio of the width of the strip electrode 1210 to the width of the first gap 121 is 1.05 to 1.5, for example, 1.1 to 1.4, for example, 1.15.

As shown in FIG. 3 and FIG. 4, a second gap 122 is provided between at least two adjacent sub-electrodes 1200 in each pixel region 134; an electrode connection portion 1220 is provided between the second gap 122 and the first gap 121; and at least a portion of the second gap 122 is surrounded by the first electrode 120. For example, the second gap 122 is not in communication with the first gap 121.

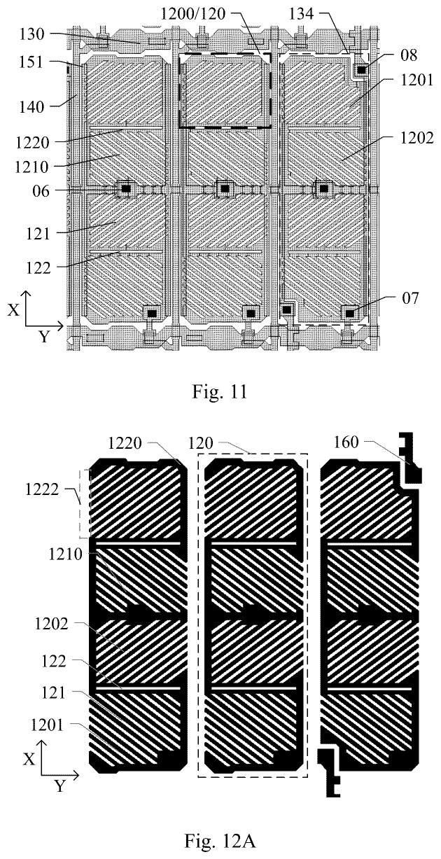

The above-described sub-electrode 1200 is an electrode circled in a dashed box in FIG. 4 and FIG. 10; the plurality of sub-electrodes 1200 included in the same first electrode 120 are connected through the electrode connection portion 1220; the second gap 122 or no gap may be provided between two adjacent sub-electrodes 1200; and the electrode connection portion 1220 is provided between strip electrodes 1210 of adjacent sub-electrodes 1200.

In the display device provided by the embodiment of the present disclosure, the plurality of sub-electrodes is provided in the same pixel region, each sub-electrode includes the plurality of strip electrodes, and the strip electrodes in different sub-electrodes have different extension directions, so that multi-domain display may be implemented in the same pixel region; moreover, the second gap is arranged between two adjacent sub-electrodes, and the electrode connection portion is provided between the second gap and the first gap, so that edges of strip electrodes in adjacent sub-electrodes that are close to each other applied with the electric field may be prevented from producing a significant impact on deflection of liquid crystal molecules in a boundary position of the two adjacent sub-electrodes, so as to alleviate deflection direction disorder of liquid crystal molecules between the two adjacent sub-electrodes, which is favorable for alleviating an inter-domain dark stripe to improve transmittance of the display device.

For example, the second gap may be a gap running through along the Y direction as shown in FIG. 4, or may also include a plurality of sub-gaps spaced apart from each other; the plurality of sub-gaps are arranged extending along the Y direction; and sizes of the plurality of sub-gaps may be the same or different, so the size of the sub-gap may be adjusted according to the positions of different sub-electrodes in the corresponding pixel region, to adjust the electric field intensity, and further adjust the liquid crystal deflection direction, so as to alleviate the inter-domain dark stripe.

In some examples, as shown in FIG. 3, one of the first display substrate 100 and the second display substrate 200 includes an alignment film 230 configured to undergo alignment treatment; and the alignment film 230 is located between the liquid crystal layer 300 and the second electrode 220. For example, only the second display substrate 200 is provided with the alignment film 230 having undergone alignment treatment; and the first display substrate 100 is provided with a film layer 03 covering the first electrode 120, in which the film layer has not undergone alignment treatment.

As compared with the display device, for example, the display device shown in FIG. 1, in which both display substrates are provided with alignment films having undergone alignment treatment, in the display device provided by the present disclosure, only one display substrate is provided with the alignment film having undergone alignment treatment, and the other display substrate is provided with the electrode structure having the plurality of strip electrodes, in which the second gap is provided between adjacent sub-electrodes while the alignment film controlling pre-tilt angles of liquid crystal molecules acts jointly with strip electrodes having different extension directions, which may alleviate the problem of deflection disorder of liquid crystal molecules between domains, and is favorable for alleviating an inter-domain dark stripe to improve transmittance of the display device.

Of course, the embodiment of the present disclosure is not limited thereto, and the first display substrate may also be provided therein with an alignment film having undergone alignment treatment.

In some examples, as shown in FIG. 4 and FIG. 10, an included angle between the strip electrode 1210 and one of the arrangement direction of the plurality of first signal lines 130 and the arrangement direction of the plurality of second signal lines 130 is 30° to 80°. For example, the included angle between the strip electrode 1210 and one of the arrangement direction of the plurality of first signal lines 130 and the arrangement direction of the plurality of second signal lines 130 is 37° to 75°. For example, the included angle between the strip electrode 1210 and one of the arrangement direction of the plurality of first signal lines 130 and the arrangement direction of the plurality of second signal lines 130 is 40° to 75°. For example, the included angle between the strip electrode 1210 and one of the arrangement direction of the plurality of first signal lines 130 and the arrangement direction of the plurality of second signal lines 130 is 45° to 70°. For example, the included angle between the strip electrode 1210 and one of the arrangement direction of the plurality of first signal lines 130 and the arrangement direction of the plurality of second signal lines 130 is 50° to 65°.

For example, as shown in FIG. 4 and FIG. 10, the included angle between the strip electrode 1210 and one of the arrangement direction of the plurality of first signal lines 130 and the arrangement direction of the plurality of second signal lines 130 is 37°, 45°, 70°, 65°, or 75°. For example, an included angle between the strip electrode 1210 and the Y direction may be 37°, 45°, 70°, 65°, or 75°.

For example, FIG. 4 schematically shows that the alignment direction 18 of the alignment film in the second display substrate is a direction indicated by a dashed arrow; and multi-domain display adjustment of liquid crystal molecules is carried out by coordinating the alignment direction with the tilt angle of the strip electrode. The liquid crystals shown in FIG. 4 are in a state after being deflected by the applied electric field. For example, the alignment direction may be substantially parallel to the extension direction of the strip electrode.

For example, when the included angle between the strip electrode 1210 and the Y direction is 37°, and the polarization direction of linearly polarized light when the alignment film undergoes alignment treatment is 45°, Δn is the minimal; and the smaller the gamma shift, the more the color shift phenomenon can be alleviated, so the smaller the Δn is, the smaller the color cast problem is. For example, the liquid crystal in the liquid crystal layer may be positive liquid crystal, for example, having a birefringence characteristic, that is, the liquid crystal respectively has refractive index ne and refractive index no different from each other in different directions; the above-described Δn refers to a difference between the refractive index ne and the refractive index no; the above-described Gamma shift refers to variation in Gamm due to different display brightness observed from different perspectives under brightness of different grayscales.

FIG. 4 schematically shows a position of a dark stripe 20 generated in one pixel region with a dashed line; and the position may be as shown in the simulated transmittance simulation diagram in FIG. 5 when the display device is displaying. As compared with the dark stripe situation of the display device shown in FIG. 2, in the display device shown in FIG. 5, multi-domain display of the liquid crystal is jointly controlled by the strip electrode and the alignment film, and the second gap not in communication with the first gap is provided between adjacent sub-electrodes, which may alleviate liquid crystal deflection disorder between adjacent sub-electrodes and reduce a dark stripe width, to improve transmittance of the display device; for example, as compared with the display device shown in FIG. 2, the display device shown in FIG. 5 has transmittance increased by 10%.

In some examples, as shown in FIG. 3 and FIG. 4, the ratio of the width of the second gap 122 to the width of the strip electrode 1210 is 0.5 to 2. By setting a relationship between the width of the second gap and the width of the strip electrode, it is favorable for adjusting pre-tilt angles of liquid crystal molecules to alleviate an inter-domain dark stripe, thereby improving transmittance of the display device.

For example, the ratio of the width of the second gap 122 to the width of the strip electrode 1210 is 0.6 to 1.8. For example, the ratio of the width of the second gap 122 to the width of the strip electrode 1210 is 0.8 to 1.5. For example, the ratio of the width of the second gap 122 to the width of the strip electrode 1210 is 1 to 1.2. For example, the width of the second gap 122 is equal to the width of the strip electrode 1210.

In some examples, as shown in FIG. 3 and FIG. 4, the width of the second gap 122 is 2 microns to 3.6 microns. For example, the width of the second gap 122 is 2.2 microns to 3.5 microns. For example, the width of the second gap 122 is 2.5 microns to 3 microns. For example, the width of the second gap 122 is 2.6 microns.

For example, as shown in FIG. 3 and FIG. 4, the first gap 121 and the second gap 122 have an equal width to further alleviate an inter-domain dark stripe and improve transmittance.

For example, as shown in FIG. 4, the second gap 122 has a shape of strip. For example, respective positions of the second gap 122 have an equal width.

For example, as shown in FIG. 4, one end of the second gap 122 may be flush with one end of the first gap 121 in the X direction, and the other end of the second gap 122 may be flush with the other end of the first gap 121 in the X direction, to adjust deflection of liquid crystals in a boundary position of adjacent domains and alleviate inter-domain dark stripe.

For example, as shown in FIG. 4 and FIG. 10, the extension direction of the first gap 121 is different from the extension direction of the second gap 122. For example, the included angle between the extension direction of the first gap 121 and the extension direction of the second gap 122 may be 30 degrees to 90 degrees. For example, the included angle between the extension direction of the first gap 121 and the extension direction of the second gap 122 may be 37 degrees to 75 degrees. For example, the included angle between the extension direction of the first gap 121 and the extension direction of the second gap 122 may be 45 degrees to 65 degrees. For example, the included angle between the extension direction of the first gap 121 and the extension direction of the second gap 122 may be 50 degrees to 70 degrees.

In some examples, as shown in FIG. 4 and FIG. 10, at least one pixel region 134 includes four sub-electrodes 1200 arranged along one of the arrangement direction of the plurality of first signal lines 130 and the arrangement direction of the plurality of second signal lines 140. For example, one pixel region 134 may have four domains.

In some examples, as shown in FIG. 4 and FIG. 10, the second gap 122 is provided between a 1-st sub-electrode 1200 and a 2-nd sub-electrode 1200; and the second gap 122 is provided between a 3-rd sub-electrode 1200 and a 4-th sub-electrode 1200. A joint action of pre-tilt angles of liquid crystal molecules corresponding to different sub-electrodes, strip electrodes, and the second gap between adjacent sub-electrodes that is not in communication with the first gap is favorable for alleviating instability of liquid crystal deflection in a boundary position of adjacent domains, and improving stability of liquid crystal deflection, to reduce the phenomenon of dark stripe.

For example, the conductive portion as shown in FIG. 6 is provided between the 2-nd sub-electrode and the 3-rd sub-electrode; and even if there is a dark stripe in the position, the second gap may not be provided.

For example, as shown in FIG. 4 and FIG. 10, the width of the second gap 122 is less than the average width of the electrode connection portion 1220 between the 2-nd sub-electrode 1200 and the 3-rd sub-electrode 1200.

For example, as shown in FIG. 4 and FIG. 10, an outer contour of the electrode 120 includes a loop of electrode connection portion 1220, and the shape of the electrode connection portion 1220 defines the shape of the electrode 120. For example, the electrode 120 may have a shape of polygon, for example, approximate quadrilateral, quadrilateral with rounded corners, or quadrilateral with four corners being flat angles. For example, the sub-electrode 1200 may have a shape of polygon, for example, approximate quadrilateral.

For example, in each sub-electrode 1200, the respective strip electrodes 1210 are each surrounded by the electrode connection portion 1220 with a closed ring shape. For example, both ends of each strip electrode 1210 are connected with the electrode connection portion 1220.

For example, as shown in FIG. 4 and FIG. 10, the second gap 122 is surrounded by the electrode connection portion 1220. For example, the first gap 121 is surrounded by the strip electrode 1210 and the electrode connection portion 1220.

For example, as shown in FIG. 3 and FIG. 4, the first signal line 130 is located on the first base substrate 110; the second signal line 140 is located on a side of the first signal line 130 that is away from the first base substrate 110; an insulation layer 01 is provided between the second signal line 140 and the first signal line 130; the first electrode 120 is located on a side of the second signal line 140 that is away from the first signal line 130; an insulation layer 02 is provided between the first electrode 120 and the second signal line 140; a transparent film layer 03 is provided on a side of the first electrode 120 that is away from the first base substrate 110, for example, the film layer 03 may be an alignment material layer having not undergone alignment treatment, but it is not limited thereto, and the film layer 03 may also be an alignment film having undergone alignment treatment.

In some examples, as shown in FIG. 3, FIG. 4, and FIG. 6 to FIG. 10, the first display substrate 100 further includes a plurality of conductive portions 150 that are arranged in the same layer as and insulated from the plurality of first signal lines 130. For example, at least one conductive portion 150 is provided between adjacent first signal lines 130; and a gap is provided between the conductive portion 150 and the first signal line 130. For example, referring to FIG. 4, two conductive portions 150 are arranged on both sides of the second signal line 140, which may play a role in shielding the data signal and avoiding impact of the data signal on a coupling capacitor between first electrodes.

In some examples, as shown in FIG. 3, FIG. 4, and FIG. 6 to FIG. 10, at least a portion of the conductive portion includes a first conductive portion 151 extending along the arrangement direction of the plurality of first signal lines 130 and a second conductive portion 152 extending along the arrangement direction of the plurality of second signal lines 140. For example, the first conductive portion 151 extends along the X direction; the second conductive portion 152 extends along the Y direction; and the first conductive portion 151 and the second conductive portion 152 are an integrated structure.

In some examples, as shown in FIG. 3, FIG. 4, and FIG. 6 to FIG. 10, along a direction perpendicular to the first base substrate 110, the first conductive portion 151 does not overlap with the second signal line 140, and both the first conductive portion 151 and the second conductive portion 152 overlap with the first electrode 120 to form a storage capacitor.

For example, as shown in FIG. 4, along the direction perpendicular to the first base substrate, the electrode connection portion 1220 of the first electrode 120 overlaps with the first conductive portion 131.

For example, as shown in FIG. 3 and FIG. 4, two first conductive portions 151 and one second signal line 140 are arranged between centers of two adjacent pixel regions 134 arranged along the Y direction; along the direction perpendicular to the first base substrate 110, the second signal line 140 does not overlap with the above-described two first conductive portions 151, and orthogonal projections of the above-described two conductive portions 151 on the first base substrate 110 are located on both sides of an orthogonal projection of the above-described second signal line 140 on the first base substrate 110 in the Y direction. For example, along the direction perpendicular to the first base substrate 110, the above-described two first conductive portions 151 both overlap with the first electrode 120 to increase the storage capacitor. Of course, the embodiment of the present disclosure is not limited thereto, and only one first conductive portion not overlapping with the second signal line may be provided between two adjacent pixel regions arranged along the Y direction.

For example, as shown in FIG. 6, one second conductive portion 152 is provided between adjacent first signal lines 130 to reduce impact on the aperture ratio of the display device. For example, the second conductive portion 152 includes a protruding block 153 with a greater width, to further increase an overlapping area between the conductive portion and the first electrode, so as to increase the storage capacitor.

For example, as shown in FIG. 4, the first display substrate further includes a thin film transistor 170; the first signal line 130 is connected with a gate electrode of the thin film transistor 170 to turn on or off the thin film transistor 170; the first electrode 120 is connected with one of a source electrode and a drain electrode of the thin film transistor 170; the second signal line 140 is connected with the other of the source electrode and the drain electrode of the thin film transistor 170; the second signal line 140 inputs a voltage signal required for displaying a picture to the first electrode 120 through the thin film transistor 170, so that the display device displays.

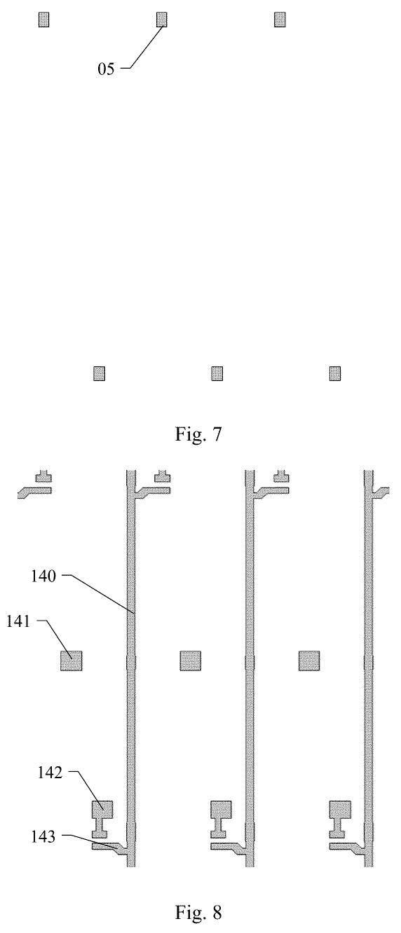

FIG. 7 shows a semiconductor layer 05. For example, as shown in FIG. 4 and FIG. 7, the semiconductor layer 05 is located on a side of the first signal line 130 that is away from the first base substrate, and overlaps with the first signal line 130, to serve as an active layer of the thin film transistor 170.

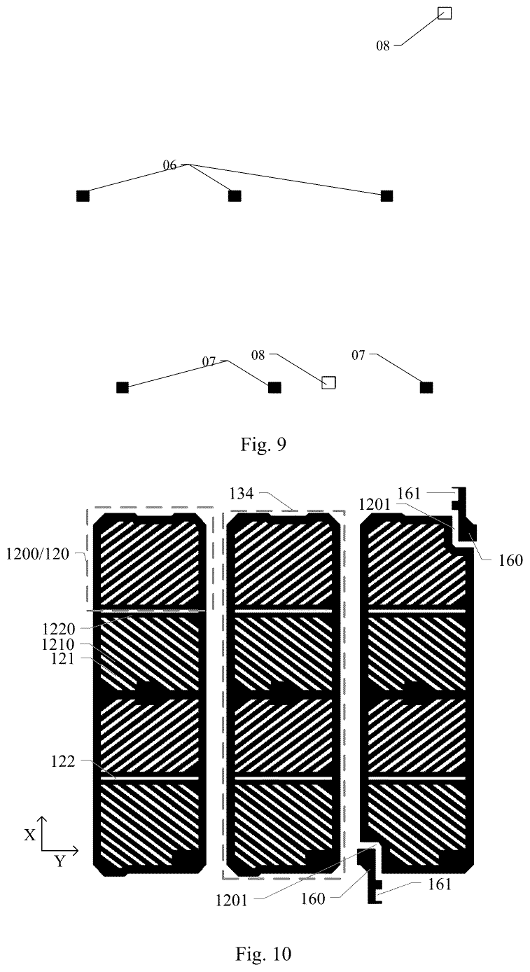

FIG. 8 shows a film layer where the second signal line 140 is located. For example, as shown in FIG. 4 and FIG. 8, the thin film transistor 170 includes a first electrode 142 and a second electrode 143; the first electrode 142 of the thin film transistor 170 is electrically connected with the first electrode 120; and the second electrode 143 of the thin film transistor 170 is electrically connected with the second signal line 140; for example, the two are an integrated structure.

FIG. 9 shows a via hole in the insulation layer located between the film layer where the second signal line is located and the film layer where the first electrode is located. For example, as shown in FIG. 4, FIG. 6, FIG. 8, FIG. 9 and FIG. 10, the first display substrate further includes a conductive structure 141 arranged in the same layer as the second signal line 140; and the conductive structure 141 is electrically connected with the first electrode 120 through a via hole 06 in the insulation layer. For example, along the direction perpendicular to the first base substrate, the conductive structure 141 overlaps with the protruding block 153, to reduce impact on the aperture ratio of the display device while forming the storage capacitor. For example, the electrode connection portion 1220 located in the middle region of the first electrode 120 has a portion with a greater width; and the portion is configured to be electrically connected with the conductive structure 141 through the via hole 06.

For example, as shown in FIG. 4, FIG. 6, FIG. 8 and FIG. 9, the first electrode 120 is electrically connected with the first electrode 142 of the thin film transistor 170 through a via hole 07.

In some examples, as shown in FIG. 3, FIG. 6, FIG. 9 and FIG. 10, the first display substrate further includes a connection structure 160 connecting conductive portions 150 located on both sides of the first signal line 130; the connection structure 160 is located in the same layer and made of the same material as, and insulated from the first electrode 120; along the direction perpendicular to the first base substrate, the connection structure 160 overlaps with the first signal line 130, and an overlapping portion of the connection structure 160 and the first signal line 130 includes a first recess 161. By providing the first recess at the overlapping portion of the connection structure and the first signal line, it is favorable for minimizing capacitance generated between the connection structure and the first signal line.

For example, as shown in FIG. 3, FIG. 6, FIG. 9 and FIG. 10, the connection structure 160 is electrically connected with a connection pad 154 of the conductive portion 150 through a via hole 08 penetrating the insulation layer between the first electrode 120 and the second signal line 140, as well as the insulation layer between the second signal line 140 and the first signal line 130, to electrically connect conductive portions located between adjacent signal lines. For example, the conductive portion may be input with a common signal, for example, the same signal as that on the second electrode.

In some examples, as shown in FIG. 4 and FIG. 10, a straight line extending along the second direction passes through the first electrode 120 and the connection structure 160; the first electrode 160 is provided with a second recess 1206 to avoid the connection structure 160; and the second recess 1206 is formed by the electrode connection portion 1220 being recessed towards one side of the strip electrode 1210. For example, orthogonal projections of the first electrode 120 on straight lines extending along the X direction and the Y direction each overlap with orthogonal projections of the connection structure 160 on corresponding straight lines; and in order to avoid interference between the first electrode 120 and the connection structure 160, an edge of the first electrode 120 is set to have a shape of the second recess 1206.

For example, as shown in FIG. 4 and FIG. 10, the first display substrate includes sub-pixels with a plurality of different colors, and the first electrode 120 of the sub-pixel with only one color is provided with the second recess 1206 to reduce impact on the aperture ratio of the display device.

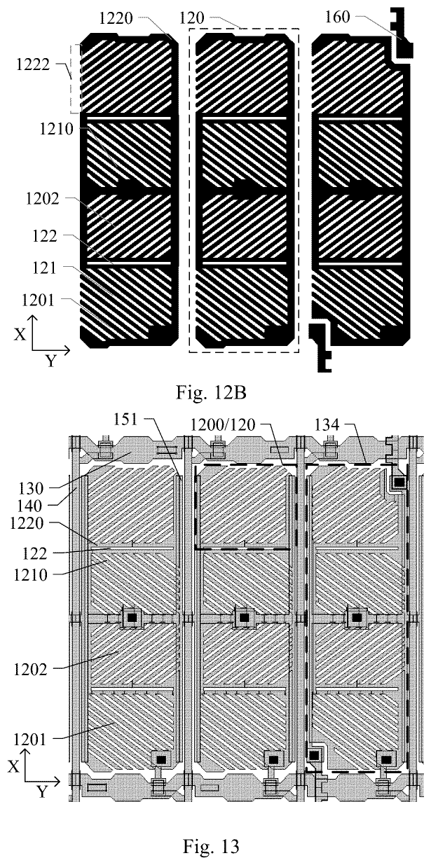

FIG. 11 is a schematic diagram of a partial planar structure of the first display substrate provided by another example according to the embodiment of the present disclosure. FIG. 12A and FIG. 12B are schematic diagrams of an arrangement structure of the film layer where the first electrode is located shown in FIG. 11 in different examples. The second display substrate, and other film layers in the first display substrate except the layer where the first electrode is located in the display device shown in FIG. 11 and FIG. 12A may have the same features as the corresponding structures in the display devices shown in FIG. 3 to FIG. 10, and no details will be repeated here. The width of the strip electrode, the width of the first gap, the width of the second gap, and the tilt angle of the strip electrode in the first electrode in the display device shown in FIG. 11 and FIG. 12A may have the same features as the corresponding structures in the display devices shown in FIG. 3 to FIG. 10, and no details will be repeated here.

The first electrode shown in FIG. 11 and FIG. 12A differs from the first electrodes shown in FIG. 4 and FIG. 10 in that at least one sub-electrode 1200 includes a ring electrode connection portion 1220 surrounding the plurality of strip electrodes 1210, the ring electrode connection portion 1220 includes an opening 1222, and the opening 1222 exposes one end of at least some strip electrodes 1210. For example, the above-described ring electrode connection portion 1220 has a shape of non-closed ring. For example, some first gaps 121 in the sub-electrode 1200 are in communication with the gap between the first electrode 120 and the signal line (e.g., the first signal line 130 and the second signal line 140) through the opening 1222, while the other first gaps 121 are not in communication with the gap between the first electrode 120 and the signal line.

In the display device provided by the present disclosure, the electrode connection portion is set to expose one end of at least some strip electrodes to adjust a deflection direction of the liquid crystal molecules corresponding to the edge of the strip electrode, which, as compared with a case where a closed ring electrode connection portion is provided at the edge of the strip electrode, is favorable for moving the dark stripe to a side far away from a center of the pixel region, for example, moving the dark stripe to a side far away from a region used for displaying, so that the dark stripe coincides with the black matrix as much as possible, which further improves transmittance of the display device.

In some examples, as shown in FIG. 11 and FIG. 12A, within the same pixel region 134, the plurality of sub-electrodes 1200 are arranged along one of the first direction and the second direction; and the opening 1222 only exposes one end of some strip electrodes 1210. For example, the plurality of sub-electrodes 1200 are arranged along the X direction; each sub-electrode 1200 includes N strip electrodes; and the number of strip electrodes 1210 exposed by the opening 1222 of the sub-electrode 1200 is no greater than N/2.

For example, as shown in FIG. 11 and FIG. 12A, in the same sub-electrode 1200, some strip electrodes 1210 each have both ends connected with the electrode connection portion 1220, while the other strip electrodes 1210 each have only one end connected with the electrode connection portion 1220. For example, in at least one sub-electrode 1200, the respective strip electrodes 1210 are all connected with the electrode connection portion 1220 surrounding the second gap 122.

For example, as shown in FIG. 11, along the direction perpendicular to the first base substrate, the strip electrode 1210 of at least one sub-electrode 1200 overlaps with the first conductive portion 151, and an overlapping portion may form a storage capacitor. For example, along the direction perpendicular to the first base substrate, each strip electrode 1210 in the same sub-electrode 1200 has one end and the other end, the one end overlaps with the first conductive portion 151, while the other end does not overlap with the first conductive portion 151; and the electrode connection portion 1220 connected with the other end overlaps with the first conductive portion 151.

In some examples, as shown in FIG. 11 and FIG. 12A, a contour shape of at least one sub-electrode 1200 includes a polygon, and the ring electrode connection portion 1220 surrounds at least two edges of the polygon. The above-described contour shape of the sub-electrode may refer to a boundary of the sub-electrode, for example, at least one edge of a region corresponding to the sub-electrode includes an opening region. For example, the ring electrode connection portion 1220 surrounds at least three edges of the polygon.

For example, as shown in FIG. 11 and FIG. 12A, a shape of at least one sub-electrode 1200 includes a quadrilateral; the electrode connection portion 1220 is provided in positions of three edges of the quadrilateral; and the opening 1222 is provided in a position of the remaining edge. The above-described quadrilateral may be an approximate quadrilateral, for example, the quadrilateral with four corners as rounded corners or flat angles.

For example, as shown in FIG. 11 and FIG. 12A, in the same first electrode 120, at least two sub-electrodes 1200 have different contour shapes. For example, in the same first electrode 120, at least two sub-electrodes 1200 have the same contour shape. For example, in the same first electrode 120, the respective sub-electrodes 1200 each include the opening 1222. For example, in the same first electrode 120, at least one sub-electrode 1200 does not include the opening 1222. For example, the respective first electrodes 120 each include the opening 1222. For example, some first electrodes 120 each include the opening 1222, while some first electrodes 120 do not include the opening 1222.

For example, as shown in FIG. 11 and FIG. 12A, in the same first electrode 120, the openings 1222 included in at least two sub-electrodes 1200 have the same size in the X direction. For example, in the same first electrode 120, the openings 1222 included in at least two sub-electrodes 1200 have different sizes in the X direction.

In the display device provided by the present disclosure, the position and the size of the opening of the sub-electrode may be adjusted with respect to positions and degrees of dark stripes in the same pixel region as well as positions and degrees of dark stripes in different pixel regions during display, so as to set the position of the opening in a targeted manner to improve the transmittance of the display device.

In some examples, as shown in FIG. 11 and FIG. 12A, the same pixel region 134 of at least one pixel region 134 includes a first sub-electrode 1201 and a second sub-electrode 1202 arranged adjacent to each other; the first sub-electrode 1201 is close to an edge of the pixel region 134; and the second sub-electrode 1202 is close to a center of the pixel region 134. For example, the second sub-electrode 1202 is located between the first sub-electrode 1201 and the center of the pixel region 134.

In some examples, as shown in FIG. 11 and FIG. 12A, an orientation of the opening 1222 of the ring electrode connection portion 1220 in the first sub-electrode 1201 is different from an orientation of the opening 1222 of the ring electrode connection portion 1220 in the second sub-electrode 1202. The above-described orientation of the opening refers to the direction of the opening relative to the center of a sub-electrode where the opening is located; for example, the opening facing rightwards indicates that the opening is located to a right side of the center of the sub-electrode, and the opening facing upwards indicates that the opening is located to an upper side of the center of the sub-electrode; here, facing rightwards may refer to a direction indicated by an arrow in the Y direction in the diagram, and facing upwards may refer to a direction indicated by an arrow in the X direction in the diagram. The above-described center of the sub-electrode refers to the geometric center of the sub-electrode.

Because positions of dark stripes generated in different positions in the pixel region are different, adjusting the opening orientation of the sub-electrode with respect to the position of dark stripe is favorable for moving the dark stripe generated in the pixel region towards a side far away from the center of the pixel region, to bring the dark stripe as close as possible to the black matrix, so as to improve the transmittance of the display device.

For example, as shown in FIG. 11 and FIG. 12A, in the same first electrode 120, the openings 1222 in at least two sub-electrodes 1200 have different orientations. For example, the same first electrode 1200 includes two sub-electrodes 1200 whose opening orientations are the same. For example, in the same first electrode 120, the openings 1222 in two sub-electrodes 1200 closest to the center thereof have the same orientation.

For example, as shown in FIG. 11 and FIG. 12A, the openings 1222 in the plurality of sub-electrodes 1200 arranged along the Y direction all have the same orientation, so as to move the dark stripe towards the same direction.

In some examples, as shown in FIG. 11 and FIG. 12A, at least one pixel region 134 includes two first sub-electrodes 1201; and the openings 1222 of the ring electrode connection portions 1220 in the two first sub-electrodes 1201 have the same orientation. For example, the respective pixel regions 134 each include two first sub-electrodes 1201; and the openings 1222 of the two first sub-electrodes 1201 have the same orientation. For example, at least one pixel region 134 includes two second sub-electrodes 1202; and the openings 1222 in the two second sub-electrodes 1202 have the same orientation.

For example, as shown in FIG. 11 and FIG. 12A, the same first electrode 120 includes four sub-electrodes 1200 arranged along the X direction; the four sub-electrodes 1200 are sequentially arranged along the X direction as the first sub-electrode 1201, the second sub-electrode 1202, the second sub-electrode 1202, and the first sub-electrode 1201. For example, an arrangement direction of the strip electrode in a 1-st sub-electrode 1200 is the same as an arrangement direction of the strip electrode in a 3-rd sub-electrode 1200, and an arrangement direction of the strip electrode in a 2-nd sub-electrode 1200 is the same as an arrangement direction of the strip electrode in a 4-th sub-electrode 1200.

In some examples, as shown in FIG. 11 and FIG. 12A, the first sub-electrodes 1201 and the second sub-electrodes 1202 are arranged along the first direction; and an orientation of the opening 1222 of the ring electrode connection portion 1220 in the first sub-electrode 1201 is opposite to an orientation of the opening 1222 of the ring electrode connection portion 1220 in the second sub-electrode 1202.

For example, as shown in FIG. 11 and FIG. 12A, the opening 1222 in the first sub-electrode 1201 faces leftwards, so that a dark stripe corresponding to the first sub-electrode 1201 moves towards the left side, for example, moves towards a side close to the second signal line 140; the opening 1222 in the second sub-electrode 1202 faces rightwards, so that a dark stripe corresponding to the second sub-electrode 1202 moves towards the right side, for example, moving towards a side close to the other second signal line 140, so as to move the dark stripes to both sides to improve transmittance.

In some examples, as shown in FIG. 11 and FIG. 12A, the first sub-electrode 1201 and the second sub-electrode 1202 are arranged along the first direction; the opening 1222 of the ring electrode connection portion 1220 in the first sub-electrode 1201 and the opening 1222 of the ring electrode connection portion 1220 in the second sub-electrode 1202 both face the second signal line 140.

In some examples, as shown in FIG. 11 and FIG. 12A, a straight line extending along the first direction passes through an edge of the strip electrode 1210 in the first sub-electrode 1201 that is exposed by the opening 1222 and an edge of the ring electrode connection portion 1220 in the second sub-electrode 1202. For example, the edge of the strip electrode 1210 of the first sub-electrode 1201 is flush with the edge of the electrode connection portion 1220 of the second sub-electrode 1202 in the X direction; and the edge of the strip electrode 1210 of the second sub-electrode 1202 is flush with the edge of the electrode connection portion 1220 of the first sub-electrode 1201 in the X direction.

In the display device provided by the present disclosure, the edge of the strip electrode in the first electrode having the opening is set to be flush with the edge of the electrode connection portion in the first direction, which is favorable for greatly extending the length of the strip electrode, to adjust the edge position thereof to be as far away from the center of the pixel region as possible, thereby ensuring that the distance between the strip electrode and the second signal line meets process requirements, while moving the dark stripe outwards as much as possible.

For example, as shown in FIG. 12A, in the same first electrode 120, edges of strip electrodes 1210 of two first sub-electrodes 1201 are flush in the first direction; and edges of strip electrodes 1210 of two second sub-electrodes 1202 are flush in the first direction. For example, in the same first electrode 120, edges of electrode connection portions 1220 of two first sub-electrodes 1201 are flush in the first direction; and edges of electrode connection portions 1220 of two second sub-electrodes 1202 are flush in the first direction.

For example, the connection structure 160 shown in FIG. 12A may have the same features as the connection structure 160 in the display devices shown in FIG. 3 to FIG. 10, and no details will be repeated here.

For example, FIG. 12A schematically shows that respective second gaps are all surrounded by the electrode connection portions, but it is not limited thereto; and at least one second gap may not be surrounded by the electrode connection portion, for example, at least one second gap may be connected to the space between the electrode connection portion and the signal line, to weaken an inter-domain dark stripe in a targeted manner.

FIG. 12B differs from FIG. 12A in that the electrode connection portion 1220 in the second sub-electrode 1202 is a closed ring structure; for example, the strip electrodes 1210 in the second sub-electrode 1202 are all surrounded by the electrode connection portion 1220, while the electrode connection portion 1220 in the first sub-electrode 1201 is a non-closed ring structure, for example, the electrode connection portion 1220 of the first sub-electrode 1201 has an opening design; the opening may face the first signal line or the second signal line, which will not be limited in the embodiments of the present disclosure.

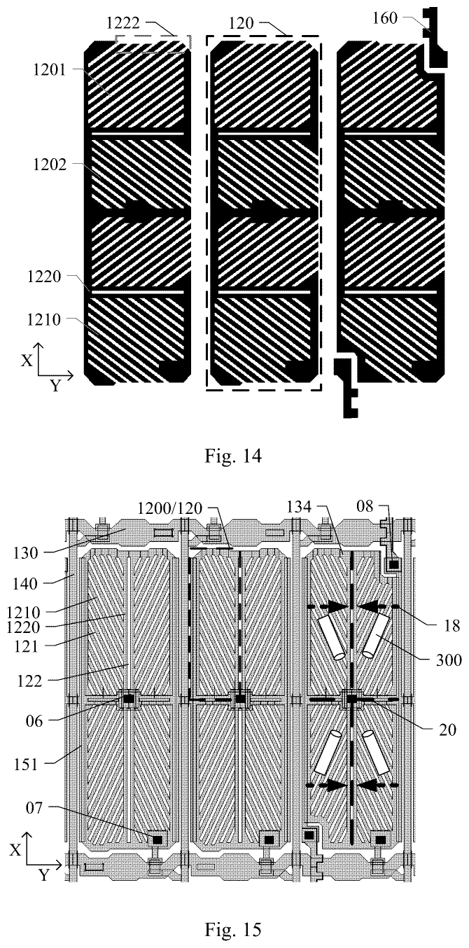

FIG. 13 is a schematic diagram of a partial planar structure of the first display substrate provided by another example according to the embodiment of the present disclosure. FIG. 14 is a schematic diagram of an arrangement structure of the film layer where the first electrode is located shown in FIG. 13. The second display substrate, and other film layers in the first display substrate except the layer where the first electrode is located in the display device shown in FIG. 13 and FIG. 14 may have the same features as the corresponding structures in the display devices shown in FIG. 3 to FIG. 10, and no details will be repeated here. The width of the strip electrode, the width of the first gap, the width of the second gap, and the tilt angle of the strip electrode in the first electrode in the display device shown in FIG. 13 and FIG. 14 may have the same features as the corresponding structures in the display devices shown in FIG. 3 to FIG. 10, and no details will be repeated here.

The first electrode shown in FIG. 13 and FIG. 14 differs from the first electrode shown in FIG. 11 and FIG. 12A in that an orientation of the opening 1222 of the ring electrode connection portion 1220 in the first sub-electrode 1201 is different. For example, in the first electrode 120 shown in FIG. 13 and FIG. 14, except that orientations of some openings 1222 are different from the orientations of the openings 1222 in the first electrode 120 shown in FIG. 11 and FIG. 12A, other features may be the same, and no details will be repeated here.

In some examples, as shown in FIG. 13 and FIG. 14, the first sub-electrode 1201 and the second sub-electrode 1202 are arranged along the first direction; the opening 1222 of the ring electrode connection portion 1220 in the first sub-electrode 1201 faces the first signal line 130; and the opening 1222 of the ring electrode connection portion 1220 in the second sub-electrode 1202 faces the second signal line 140.

For example, as shown in FIG. 13 and FIG. 14, the opening 1222 of the first sub-electrode 1201 faces upwards or downwards, to move the dark stripes upwards or downwards, for example, move towards the direction close to the first signal line 130; the opening 1222 of the second sub-electrode 1202 faces rightwards, to move the dark stripe rightwards, for example, move towards the direction close to the second signal line 140, thereby improving transmittance of the display device.

For example, as shown in FIG. 13 and FIG. 14, the first electrode 120 includes four sub-electrodes 1200 arranged along the X direction; openings 1222 of the two first sub-electrodes 1201 located on both sides respectively faces upwards and downwards; openings 1222 of the two second sub-electrodes 1202 located in the middle both face rightwards, to move the dark stripes upwards, downwards, and rightwards.

For example, as shown in FIG. 13 and FIG. 14, the edge of the strip electrode 1210 of the second sub-electrode 1202 is flush with the edge of the electrode connection portion 1220 of the first sub-electrode 1201 in the X direction, which is favorable for greatly extending the length of the strip electrode, to adjust the edge position thereof to be as far away from the center of the pixel region as possible, thereby ensuring that the distance between the strip electrode and the second signal line meets process requirements, while moving the dark stripe outwards as much as possible.

Of course, the embodiment of the present disclosure is not limited thereto, and the opening directions of the first electrodes shown in FIG. 12A and FIG. 14 may also be combined, for example, the first electrode includes two first sub-electrodes, and an opening of the ring electrode connection portion in one of the two first sub-electrodes faces the first signal line, while an opening of the ring electrode connection portion in the other of the two first sub-electrodes faces the second signal line; or, in the same first sub-electrode, the same opening has one portion face the first signal line and the other portion face the second signal line.

For example, as shown in FIG. 3 to FIG. 14, among two adjacent sub-electrodes 1200 arranged in the X direction, at least some strip electrodes 1210 respectively located in two sub-electrodes 1200 are symmetrically distributed with a straight line extending along the Y direction as an axis of symmetry. For example, strip electrodes 1210 in the first sub-electrode 1201 and the second sub-electrode 1202 arranged adjacent to each other are symmetrically distributed with the second gap 122 as an axis of symmetry. For example, strip electrodes 1210 in two second sub-electrodes 1202 arranged adjacent to each other are symmetrically distributed with the second conductive portion 151 as an axis of symmetry.

For example, as shown in FIG. 3 to FIG. 14, the same first electrode 120 includes two second gaps 122; and two second sub-electrodes 1202 are provided between the two second gaps 122.

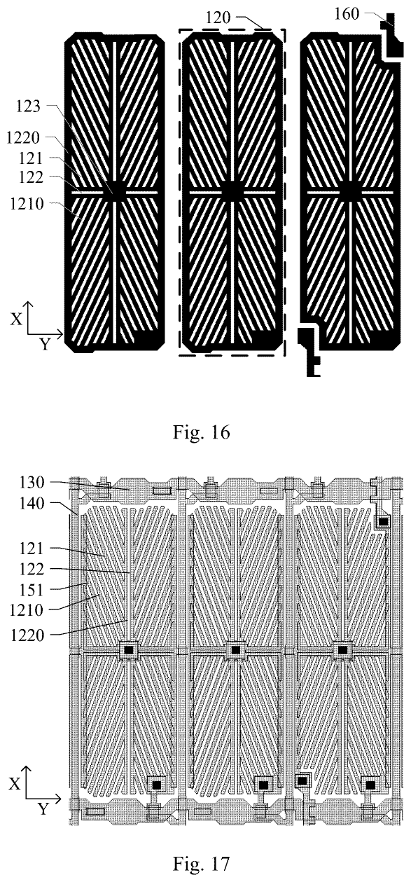

FIG. 15 is a schematic diagram of a partial planar structure of the first display substrate provided by another example according to the embodiment of the present disclosure. FIG. 16 is a schematic diagram of an arrangement structure of the film layer where the first electrode is located shown in FIG. 15. The second display substrate, and other film layers in the first display substrate except the layer where the first electrode is located in the display device shown in FIG. 15 and FIG. 16 may have the same features as the corresponding structures in the display devices shown in FIG. 3 to FIG. 10, and no details will be repeated here.

In some examples, as shown in FIG. 15 and FIG. 16, in the same pixel region 134, a plurality of sub-electrodes 1200 are arranged in an array along the first direction and the second direction; a second gap 122 is provided between adjacent sub-electrodes 1200 arranged along the first direction; and a second gap 122 is provided between adjacent sub-electrodes 1200 arranged along the second direction. The width of the strip electrode and a tilt angle selection range thereof, the width of the first gap, the width of the second gap, the width relationship among the first gap, the second gap and the strip electrode in the display device shown in FIG. 15 and FIG. 16 may have the same features as the corresponding structures in the display devices shown in FIG. 3 to FIG. 10, and no details will be repeated here.

For example, FIG. 15 schematically shows that the alignment direction 18 of the alignment film in the second display substrate is the direction indicated by the dashed arrow; and multi-domain display adjustment of liquid crystal molecules is carried out by coordinating the alignment direction with the tilt angle of the strip electrode. The liquid crystal shown in FIG. 15 is in a state after being deflected by an applied electric field. For example, the alignment direction and the extension direction of the strip electrode have a certain included angle; for example, the included angle is greater than 0 degrees and less than 45 degrees. FIG. 15 also schematically shows the position of the dark stripe 20, for example, the dark stripe 20 presents a cross shape. The alignment film material in the first display substrate in the display device shown in FIG. 15 has not undergone alignment treatment.

In the display device provided by the embodiment of the present disclosure, the plurality of sub-electrodes is provided in the same pixel region, and each sub-electrode includes the plurality of strip electrodes, which is favorable for controlling multi-domain display of liquid crystal molecules in the liquid crystal layer; moreover, the alignment film controlling the pre-tilt angle of the liquid crystal molecules, strip electrodes with different extension directions, and the second gap arranged between adjacent sub-electrodes that is not in communication with the first gap act jointly, which may alleviate the problem of inter-domain liquid crystal molecule deflection disorder, and is favorable for alleviating an inter-domain dark stripe to improve transmittance of the display device.

For example, as shown in FIG. 15 and FIG. 16, four second gaps 122 are provided in the same first electrode 120; and electrode connection portions 1220 are provided between the four second gaps 122, for example, different second gaps 122 in the same first electrode 120 are not connected with each other.

For example, as shown in FIG. 15 and FIG. 16, second gaps 122 in the same first electrode 120 each have a shape of cross. For example, electrode connection portions 1220 between a plurality of second gaps 122 in the same first electrode 120 each include a structure 123; and the structure 123 is configured to be electrically connected with the conductive structure 141 shown in FIG. 8.

For example, as shown in FIG. 15 and FIG. 16, in the same first electrode 120, strip electrodes 1210 in adjacent sub-electrodes 1200 arranged along the X direction are symmetrically distributed; and strip electrodes 1210 in adjacent sub-electrodes 1200 arranged along the Y direction are symmetrically distributed.

For example, as shown in FIG. 15 and FIG. 16, in the same first electrode 120, strip electrodes 1210 in the plurality of sub-electrodes 1200 are distributed divergently with the center of the first electrode 120 as the center thereof.

In some examples, as shown in FIG. 15 and FIG. 16, at least one sub-electrode 1200 includes a closed ring electrode connection portion 1220 surrounding the plurality of strip electrodes 1210.

For example, as shown in FIG. 15 and FIG. 16, in the direction perpendicular to the first base substrate, the electrode connection portion 1220 overlaps with the first conductive portion 151; and the strip electrode 1210 does not overlap with the first conductive portion 151

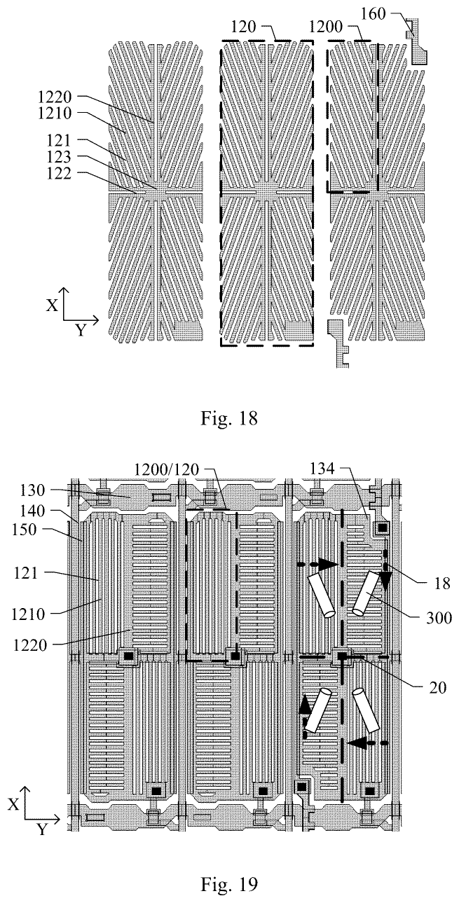

FIG. 17 is a schematic diagram of a partial planar structure of the first display substrate provided by another example according to the embodiment of the present disclosure. FIG. 18 is a schematic diagram of an arrangement structure of the film layer where the first electrode is located shown in FIG. 17. The second display substrate, and other film layers in the first display substrate except the layer where the first electrode is located in the display device shown in FIG. 17 and FIG. 18 may have the same features as the corresponding structures in the display devices shown in FIG. 3 to FIG. 10, and no details will be repeated here.

The display devices shown in FIG. 17 and FIG. 18 differs from the display devices shown in FIG. 15 and FIG. 16 in that more than 90% of the electrode connection portion 1220 is located between the plurality of strip electrodes 1210 of sub-electrodes 1200 arranged adjacent to each other in the same pixel region 134. For example, more than 95% of the electrode connection portion 1220 is located between the plurality of strip electrodes 1210 of sub-electrodes 1200 arranged adjacent to each other in the same pixel region 134. For example, the strip electrode 1210 is not surrounded by the electrode connection portion 1220.

For example, as shown in FIG. 17 and FIG. 18, in the same first electrode 120, at least some strip electrodes 1210 each only have one end connected with the electrode connection portion 1220. For example, in the same first electrode 120, the respective strip electrodes 1210 each only have one end connected with the electrode connection portion 1220.

For example, as shown in FIG. 17 and FIG. 18, along the direction perpendicular to the first display substrate, strip electrodes 1210 of the same first electrode 120 overlap with the first conductive portion 151; and the electrode connection portion 1220 includes a portion overlapping with the first conductive portion 151.

For example, as shown in FIG. 18, at least one second gap 122 is not completely surrounded by the electrode connection portion 1220; for example, at least one second gap 122 may be in communication with a space between the first electrode and the signal line. By setting at least one second gap as a non-closed gap, it is favorable for adjusting a deflection direction of the liquid crystal in the edge position of the first electrode, and alleviating the phenomenon of liquid crystal deflection disorder, to reduce dark stripes, and improve transmittance of the display device.

For example, as shown in FIG. 18, the respective second gaps 122 are all non-closed gaps; and the respective second gaps 122 each have one end extend to the structure 123.

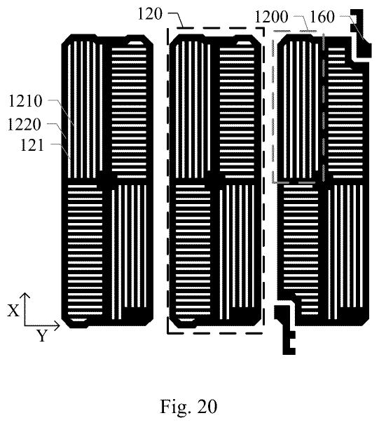

FIG. 19 is a schematic diagram of a partial planar structure of a display device provided by another embodiment of the present disclosure. FIG. 20 is a schematic diagram of an arrangement structure of the film layer where the first electrode is located shown in FIG. 19.

The second display substrate, and other film layers in the first display substrate except the layer where the first electrode is located in the display device shown in FIG. 19 and FIG. 20 may have the same features as the corresponding structures in the display devices shown in FIG. 3 to FIG. 10, and no details will be repeated here. The display device includes the first display substrate, the second display substrate, and the liquid crystal layer located between the first display substrate and the second display substrate as shown in FIG. 3. The first display substrate includes the first base substrate, as well as the plurality of first electrodes, the plurality of first signal lines, and the plurality of second signal lines located on the first base substrate; the plurality of first signal lines is arranged along the first direction; the plurality of second signal lines is arranged along the second direction; the first direction intersects with the second direction; the second display substrate is located on a side of the plurality of first electrodes that is away from the first base substrate; the second display substrate includes the second base substrate and the second electrode located on a side of the second base substrate that faces the first display substrate. The plurality of first signal lines and the plurality of second signal lines intersect with each other to define the plurality of pixel regions; and first electrodes in different pixel regions are insulated from each other.

As shown in FIG. 19 and FIG. 20, in at least some pixel regions 134, first electrodes 120 within the same pixel region 134 each include a plurality of sub-electrodes 1200 electrically connected with each other; each sub-electrode 1200 includes a plurality of strip electrodes 1210; a first gap 121 is provided between adjacent strip electrodes 1210 in each sub-electrode 1200; extension directions of strip electrodes 1210 located in adjacent sub-electrodes 1200 are respectively parallel to the first direction and the second direction, for example, an X direction and a Y direction; and the first electrode 120 further includes a closed ring electrode connection portion 1220 surrounding the plurality of strip electrodes 1210 of the respective sub-electrodes 1200.

For example, FIG. 19 schematically shows that the alignment direction 18 of the alignment film in the second display substrate is a direction indicated by a dashed arrow; and multi-domain display adjustment of liquid crystal molecules is carried out by coordinating the alignment direction with the tilt angle of the strip electrode. FIG. 19 also schematically shows a position of a dark stripe 20, for example, the dark stripe 20 presents a cross shape. The liquid crystal shown in FIG. 19 is in a state after being deflected by an applied electric field. For example, the alignment direction and the extension direction of the strip electrode may have a certain included angle, for example, the included angle may be between 80 degrees to 100 degrees, for example, 90 degrees. For example, the alignment material layer in the first display substrate according to this embodiment has not undergone alignment treatment, that is, liquid crystal deflection is not aligned.

In the display device provided by the embodiment of the present disclosure, the alignment directions of the alignment films in the respective display substrates are matched with the extension directions of strip electrodes in different sub-electrodes while providing the plurality of sub-electrodes including strip electrodes in the first electrode, and the electrode connection portion is set as a closed ring, which is favorable for alleviating the phenomenon of liquid crystal molecule deflection disorder at a boundary of adjacent sub-electrodes, thereby alleviating a dark stripe phenomenon and improving transmittance of the display device.

In some examples, as shown in FIG. 19 and FIG. 20, in at least one pixel region 134, the same pixel region 134 includes four sub-electrodes 1200 arranged in an array along the first direction and the second direction. For example, different sub-electrodes 1200 have substantially the same area.

The following statements should be noted:
(1) The accompanying drawings involve only the structure(s) in connection with the embodiment(s) of the present disclosure, and other structure(s) can be referred to common design(s).
(2) In case of no conflict, features in one embodiment or in different embodiments can be combined.

What have been described above are only specific implementations of the present disclosure, the protection scope of the present disclosure is not limited thereto. The protection scope of the present disclosure should be based on the protection scope of the claims.

1. A display device, comprising:
a first display substrate, comprising a first base substrate, as well as a plurality of first electrodes, a plurality of first signal lines, and a plurality of second signal lines located on the first base substrate, an arrangement direction of the plurality of first signal lines intersecting with an arrangement direction of the plurality of second signal lines;
a second display substrate, located on a side of the plurality of first electrodes that is away from the first base substrate, the second display substrate comprising a second base substrate and a second electrode located on a side of the second base substrate that faces the first display substrate;
a liquid crystal layer, located between the first display substrate and the second display substrate,
wherein the plurality of first signal lines intersects with the plurality of second signal lines to define a plurality of pixel regions, and first electrodes in different pixel regions are insulated from each other;
in at least some pixel regions, the first electrode within a same pixel region comprises a plurality of sub-electrodes electrically connected with each other, each sub-electrode comprises a plurality of strip electrodes and an electrode connection portion connected with the plurality of strip electrodes, a first gap is disposed between adjacent strip electrodes in each sub-electrode, and extension directions of strip electrodes in adjacent sub-electrodes intersect with each other;
a second gap is disposed between at least two adjacent sub-electrodes in each pixel region, the electrode connection portion is disposed between the second gap and the first gap, and at least a portion of the second gap is surrounded by the first electrode.

2. The display device according to claim 1, wherein at least one sub-electrode comprises the electrode connection portion with non-closed ring shape surrounding the plurality of strip electrodes, the electrode connection portion comprises an opening, and the opening exposes one end of at least some strip electrodes.

3. The display device according to claim 2, wherein the plurality of first signal lines is arranged along a first direction, and the plurality of second signal lines is arranged along a second direction;
in a same pixel region, the plurality of sub-electrodes is arranged along one of the first direction and the second direction, and the opening only exposes one end of some strip electrodes.

4. The display device according to claim 3, wherein a contour shape of the at least one sub-electrode comprises a polygon, and the electrode connection portion surrounds at least two edges of the polygon.

5. The display device according to claim 1, wherein two adjacent sub-electrodes within a same pixel region of at least one pixel region comprise electrode connection portions with non-closed ring shape surrounding the plurality of strip electrodes, the electrode connection portion comprises an opening, and the opening expose one end of some strip electrodes;
the same pixel region of the at least one pixel region comprises a first sub-electrode and a second sub-electrode arranged adjacent to each other, the first sub-electrode is close to an edge of the same pixel region, and the second sub-electrode is close to a center of the same pixel region;
an orientation of the opening of the electrode connection portion in the first sub-electrode is different from an orientation of the opening of the electrode connection portion in the second sub-electrode.

6. The display device according to claim 5, wherein the plurality of first signal lines is arranged along a first direction, and the plurality of second signal lines is arranged along a second direction;
the first sub-electrode and the second sub-electrode are arranged along the first direction, the opening of the electrode connection portion in the first sub-electrode faces the first signal line, and the opening of the electrode connection portion in the second sub-electrode faces the second signal line.

7. The display device according to claim 5, wherein the orientation of the opening of the electrode connection portion in the first sub-electrode is opposite to the orientation of the opening of the electrode connection portion in the second sub-electrode.

8. The display device according to claim 5, wherein the plurality of first signal lines is arranged along a first direction, the plurality of second signal lines is arranged along a second direction, and the first sub-electrode and the second sub-electrode are arranged along the first direction;
the at least one pixel region comprises two first sub-electrodes, openings of electrode connection portions in the two first sub-electrodes have a same orientation; or the opening of the electrode connection portion in one of the two first sub-electrodes faces the first signal line, and the opening of the electrode connection portion in the other of the two first sub-electrodes faces the second signal line.

9. The display device according to claim 7, wherein the plurality of first signal lines is arranged along a first direction, and the plurality of second signal lines is arranged along a second direction;
the first sub-electrode and the second sub-electrode are arranged along the first direction, the opening of the electrode connection portion in the first sub-electrode and the opening of the electrode connection portion in the second sub-electrode both face the second signal line, and a straight line extending along the first direction passes through an edge of the strip electrode in the first sub-electrode that is exposed by the opening and an edge of the electrode connection portion in the second sub-electrode.

10. The display device according to claim 1, wherein the at least one pixel region comprises four sub-electrodes arranged along one of the arrangement direction of the plurality of first signal lines and the arrangement direction of the plurality of second signal lines; among the four sub-electrodes, the second gap is provided between a 1-st sub-electrode and a 2-nd sub-electrode, and the second gap is provided between a 3-rd sub-electrode and a 4-th sub-electrode.

11. The display device according to claim 1, wherein the plurality of first signal lines is arranged along a first direction, and the plurality of second signal lines is arranged along a second direction;
in a same pixel region, the plurality of sub-electrodes is arranged in an array along the first direction and the second direction, the second gap is provided between adjacent sub-electrodes arranged along the first direction, and the second gap is provided between adjacent sub-electrodes arranged along the second direction.

12. The display device according to claim 11, wherein at least one sub-electrode comprises the electrode connection portion with a closed ring shape surrounding the plurality of strip electrodes.

13. The display device according to claim 11, wherein more than 90% of the electrode connection portion is located between the plurality of strip electrodes of sub-electrodes arranged adjacent to each other in a same pixel region.

14. The display device according to claim 1, wherein an included angle between the strip electrode and one of the arrangement direction of the plurality of first signal lines and the arrangement direction of the plurality of second signal lines is 30° to 80°.

15. The display device according to claim 1, wherein a width of the strip electrode is 2 microns to 4 microns, and a width of the first gap is 2 microns to 4 microns.

16. The display device according to claim 1, wherein a width of the second gap is 2 microns to 3.6 microns, and a ratio of the width of the second gap to a width of the strip electrode is 0.5 to 2.

17. The display device according to claim 1, wherein one of the first display substrate and the second display substrate comprises an alignment film having undergone alignment treatment, the alignment film is located between the liquid crystal layer and the second electrode; or, both the first display substrate and the second display substrate comprise alignment films having undergone alignment treatment.

18. The display device according to claim 1, wherein the first display substrate further comprises a plurality of conductive portions arranged in the same layer as, and insulated from, the plurality of first signal lines, at least some conductive portions comprise a first conductive portion extending along the arrangement direction of the plurality of first signal lines and a second conductive portion extending along the arrangement direction of the plurality of second signal lines, in a direction perpendicular to the first base substrate, the first conductive portion does not overlap with the second signal line, and both the first conductive portion and the second conductive portion overlap with the first electrode.

19. and 20. (canceled)

21. A display device, comprising:
a first display substrate, comprising a first base substrate, as well as a plurality of first electrodes, a plurality of first signal lines, and a plurality of second signal lines located on the first base substrate, the plurality of first signal lines being arranged along a first direction, the plurality of second signal lines being arranged along a second direction, and the first direction intersecting with the second direction;
a second display substrate, located on a side of the plurality of first electrodes that is away from the first base substrate, the second display substrate comprising a second base substrate and a second electrode located on a side of the second base substrate that faces the first display substrate;
a liquid crystal layer, located between the first display substrate and the second display substrate,
wherein the plurality of first signal lines intersects with the plurality of second signal lines to define a plurality of pixel regions, and first electrodes in different pixel regions are insulated from each other;
in at least some pixel regions, the first electrode within a same pixel region comprises a plurality of sub-electrodes electrically connected with each other, each sub-electrode comprises a plurality of strip electrodes, a first gap is provided between adjacent strip electrodes in each sub-electrode;
extension directions of strip electrodes located in adjacent sub-electrodes are respectively parallel to the first direction and the second direction, and each sub-electrode further comprises a closed ring electrode connection portion surrounding the plurality of strip electrodes.

22. The display device according to claim 21, wherein, in at least one pixel region, a same pixel region comprises four sub-electrodes arranged in an array along the first direction and the second direction.
